(19) United States
(12) Patent Application Publication
(10) Pub. No.: US 2019/0108056 A1
(43) Pub. Date: Apr. 11, 2019

(54) PERIODIC PERMISSION SYSTEM FOR CONTROLLING A DEVICE PROVIDING DISTRIBUTED CONTENT

(71) Applicant: Jack Rainieri, Bayville, NJ (US)

(72) Inventor: Jack Rainieri, Bayville, NJ (US)

(21) Appl. No.: 15/729,029

(22) Filed: Oct. 10, 2017

(51) Int. Cl. G06F 9/48; G09B 7/04; H04L 29/08; G06F 9/451

(52) U.S. Cl. CPC G06F 9/4825; G09B 7/04; G09B 5/02; G06F 9/451; H04L 67/22

(57) ABSTRACT

A periodic permission system for controlling access to distributed content of a device such as television or cable programming or an electronic game. The system is controlled by an administrator, and periodically interrupts distributed content to pose questions to a user of the device. Normal operation of the device is restored when the user responds to the questions. An interruption schedule may be established by the administrator. The system may be education oriented, and interrupt the distributed content to pose questions from educational lessons and to monitor homework performance.

### FIELD OF THE DISCLOSURE

The present disclosure relates to devices for providing distributed content on e.g. a screen, and periodically interrupting the distributed content pending a response to a question posed by a periodic permission system controlling delivery of distributed content.

### BACKGROUND

The advent of electronic communications devices, encompassing television, cable content, personal computers, tablets, smart phones, and dedicated electronic game devices, are engrossing to youngsters. While electronic communications have their place, they also have the potential to cause youngsters to ignore duties and responsibilities. Notably, youngsters and even others can find electronic communications engaging to the point of addiction. One response is to prevent youngsters from using electronic communications devices. However, that may be deemed an overreaction.

One type of duty or responsibility frequently imposed on youngsters is attending to education lessons. If a youngster is overly engrossed with electronic communications devices, he or she may neglect studies. As with so many things, a balance between recreational use of electronic communications devices and attention to education is desirable.

There exists a need to implement this balance without unduly treading on one option or the other.

### SUMMARY

The disclosed concepts address the above stated situation by providing a way of minimally and selectively stopping excessive use of electronic communications devices, and imposing attention to scholastic or educational activities. To this end, the present invention contemplates a supervisory system for enabling use of an electronic communications device, while imposing periodic attention to scholastic or educational activities. Illustratively, a supervisory control system is incorporated in conjunction with use of the electronic communications device such that recreational use of the latter is periodically interrupted to interpose a scholastic or educational exercise. Continued recreational use is conditional, based on appropriate response by the user of the electronic communications device responsive to prompts provided by the supervisory control system.

The prompts may for example take the form of tests posing questions, requirements for writing essays, and other scholastic or educational activities. Acceptable completion of a test or writing requirement then restores recreational content functions of the electronic communications device.

The youngster is not barred from using the electronic communications device for recreational purposes, but still is obliged to fulfill scholastic or educational duties and responsibilities.

This is done automatically, without requiring presence or constant monitoring by an adult caregiver. A supervisory control may be carried within the electronic device, e.g., by downloading and having operating parameters preset by an adult administrator, by remote communications, and in other ways. The user knows that recreational privileges will be restored upon his or her appropriate participation, so that voluntary compliance is encouraged.

It is an object to provide improved elements and arrangements thereof by apparatus for the purposes described which is inexpensive, dependable, and fully effective in accomplishing its intended purposes.

This and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a diagrammatic overview of components and participants of a periodic permission system for controlling access to an electronic communications device;

FIG. 2 is a view of content displayed on a screen of the electronic communications device in ordinary use, according to at least one aspect of the disclosure;

FIG. 3 is a view of modified content displayed on the screen of the electronic communications device showing an optional advisory message, according to at least one aspect of the disclosure;

FIG. 4 is a view of content displayed on the screen of the electronic communications device, showing an exemplary scholastic or educational exercise as it is initially presented to the user, according to at least one aspect of the disclosure; and

FIG. 5 is a view of further content displayed on the screen of the electronic communications device showing an exemplary feedback response by the administrative system of the electronic communications device, according to an aspect of the disclosure.

### DETAILED DESCRIPTION

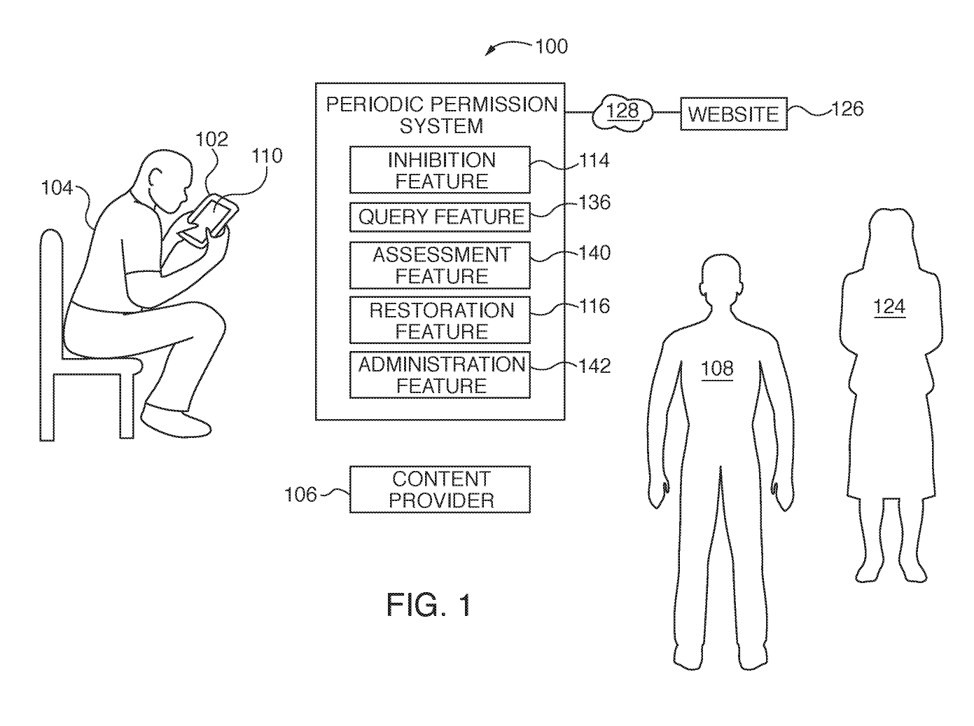

FIG. 1 provides a diagrammatic overview of a periodic permission system 100 for controlling access to an electronic communications device 102 operated by a user 104, an authorized administrator 108 of periodic permission system 100, a source 106 of ordinary content to be displayed on electronic communications device 102, and functional features of periodic permission system 100. Source 106 of content may be carried aboard electronic communications device 102, e.g., in a memory (not shown), or alternatively, may be supplied remotely. Electronic communications device 102 may be for example, a personal computer, a tablet, a smartphone, a stand-alone or dedicated game device operating a video game for user 104, for example, or any other electronic device capable of displaying images such as those referred to hereinafter. Periodic permission system 100 will also be understood to include audio content and features as well as visible content and features. Therefore, in periodic permission system 100, the sensible output of device 102 may comprise at least one of an electronically operated display screen and an electronically operated speaker (neither separately shown).

The principal purpose of periodic permission system 100 is to enable ordinary use of electronic communications device 102, and to periodically interrupt ordinary use to oblige user 104 to respond to one or more queries posed by periodic permission system 100. Hereinafter, queries will be referred to in the singular, but will be understood to encompass plural queries. Ordinary use signifies presentation of content on screen 110 (and via audible output via e.g., a microphone, not shown, where appropriate) for the purposes of the originator of the content. Content may be for amusement, such as television and cable broadcasts, electronic game players, and the like. Content may also be proprietary.

Functionalities and modules of periodic permission system 100 may be incorporated into electronic communications device 102 as e.g., firmware or downloadable software, may be contained in a data storage and transfer device such as a memory card (not shown) or may be remotely supplied.

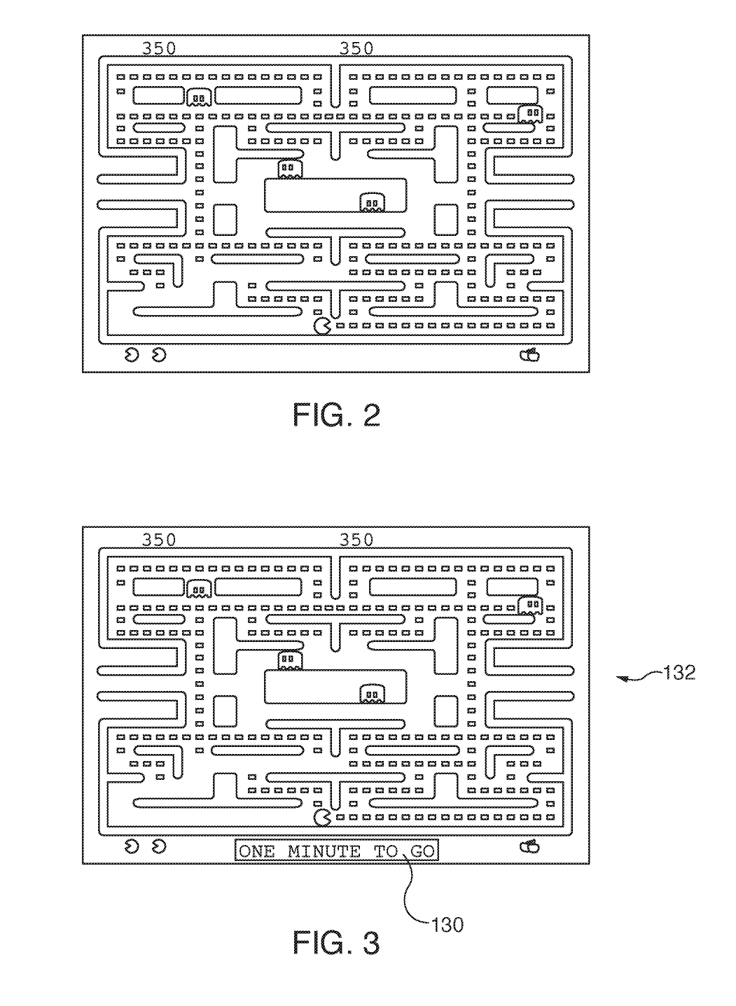

FIG. 2 illustrates an example of content which may be displayed on a screen 110. In this example, an electronic game is presented on screen 110. In the screen content depicted in FIG. 2, no feature of periodic permission system 100 has come into play. Content shown as screen 134 in FIG. 2 is a game, and may be regarded as ordinary content. Ordinary content is that content provided by content provider 106, and does not include content from periodic permission system 100.

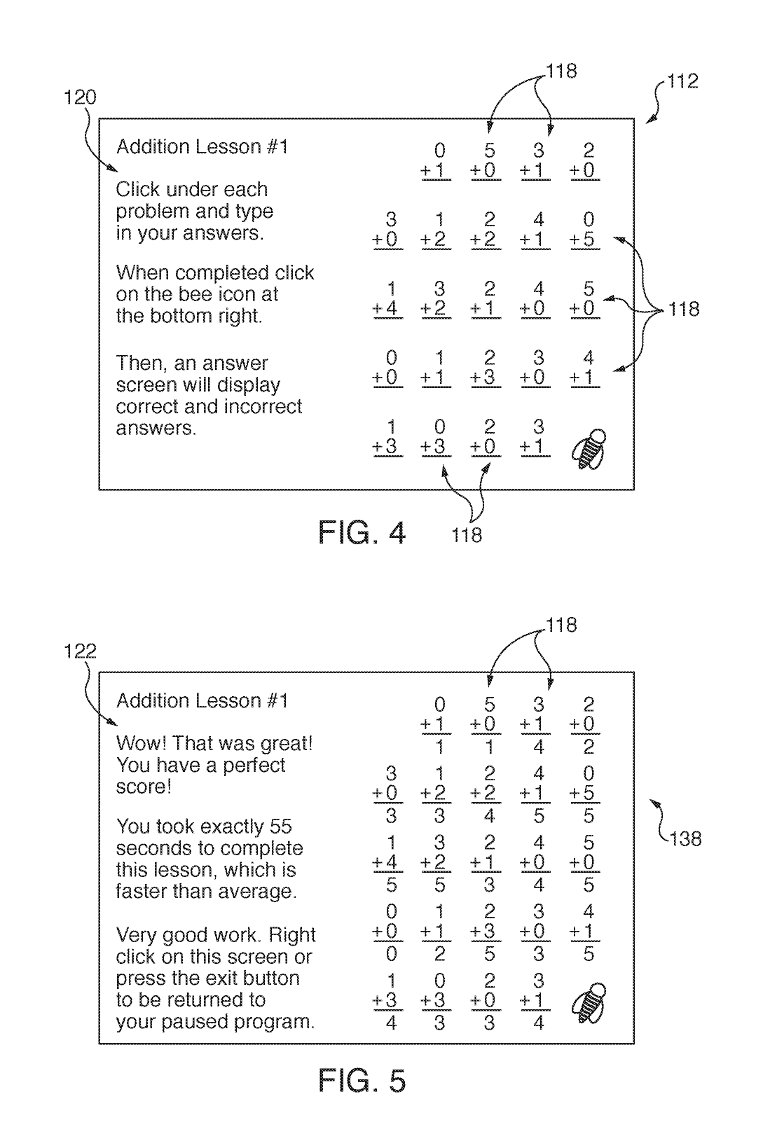

Periodic permission system 100 is for controlling access of 104 user to device 102 having a control circuit and a sensible output (e.g., screen 110). Periodic permission system 100 is controllable by authorized administrator 108 and is coupled to the control circuit of device 102. Periodic permission system 100 may further comprise an inhibition feature 114 periodically interrupting and inhibiting routine function of the sensible output of device 102 until user 104 has entered a response as data responsive to at least one query generated by periodic permission system 100 and made available to user 104 using the sensible output. Periodic permission system 100 may further comprise a restoration feature 116 restoring the routine function of device 102 responsive to user 104 entering a response to the query. Of course, periodic permission system 100 includes a query feature 136 for generating queries 118, shown as screen 112 in FIG. 4

In periodic permission system 100, the control circuit may comprise a microprocessor (not separately shown, but which may be part of electronic communications device 102 for example) Inhibition feature 114 and restoration feature 116 may be embodied in a dedicated module in supervisory control relationship to the microprocessor. The dedicated module may be under control of authorized administrator 108. The dedicated module may include a time setting functionality controllable by authorized administrator 108, wherein time frequency of periodic interrupting and inhibiting is established by authorized administrator 108.

Now referring additionally to FIGS. 3-5 generally and more specifically to FIG. 4, according to at least one aspect of the disclosure, there is shown an optional opening screen 112 of periodic permission system 100. As used herein, the term “screen” may refer to physical screen 110 depicted in FIG. 1, or alternatively, to content shown on screen 110. FIG. 1 shows physical screen 110. In FIGS. 2-5, reference to “screen” may refer to content displayed on physical screen 110.

Opening screen 112 presents a query to user 104. More specifically, in the example of FIG. 4, the query is actually a plurality of queries 118, wherein each query 118 is an arithmetical addition problem to be solved by user 104. Alternatively stated, each query 118 is a question taken from an educational lesson, and the data responsive to the query comprises an answer to the question. Queries 118 are accompanied by instructions 120 displayed on screen 110.

Answers are not shown in FIG. 4, but are shown in FIG. 5, to which reference is now made. FIG. 5 shows the original questions (i.e., queries 118), and also answers to the questions, and commentary 122 generated by periodic permission system 100. Commentary may include correct answers to queries 118, where user 104 has entered incorrect answers. The content of screen 138 of FIG. 5 represents an assessment feature 140, where the assessment identifies correct and incorrect answers, and may also determine a score.

Periodic permission system 100 may further comprise a functionality wherein an incorrectly answered query 118 is repeated as a new query 118, e.g., in a subsequent cycle of interruption and querying.

Optionally, query 118 and the response(s) are maintained in memory of device 102 (or other memory enabled component of periodic permission system 100) and are retrievable for viewing.

Periodic permission system 100 may further comprising a functionality of establishing a third party 124 as a subordinate authorized administrator authorized to establish at least partial content of the query. Authorized administrator 108 may be a parent for example. Third party 124 (which may of course comprise more than one person) may be a teacher for example. Content of the query may comprise test questions and academic exercises initiated by the teacher. It may be more appropriate to have a teacher to establish specific queries, whereas the parent may be more appropriate to set parameters on use of device 102. An administration feature 142 is functional to receive and process inputs from authorized administrator 108, and optionally, any subordinate authorized administrator, such as third party 124.

In one implementation, periodic permission system 100 may be administered from a website by a website operator (website and operator are shown collectively as 126) and uses the internet 128 as a communications link. The website operator may be a school district for example, using periodic permission system 100 as an adjunct for teaching and testing many students remotely. Where periodic permission system 100 is implemented through website 126, the teacher (not separately shown) may access device 102 by logging into website 126. Where periodic permission system 100 is implemented through website 126, or is otherwise remotely operated using the internet 128, query 118 and parameters of operation may comprise modules downloadable through the internet 128, and through data storage apparatus connectable to device 102 in data transfer relationship. Data storage apparatus may comprise memory sticks, compact discs, and other data storage items (none shown). Where periodic permission system 100 uses the internet 128, participation of at least one of third party 124 and of user 104 is password protected.

In an optional form, periodic permission system 100 may further comprise a functionality of distinguishing between primary content and commercial messages, and initiating the inhibition feature when identifying a commercial message. This feature minimizes interruptions to the content displayed on screen 110, in the sense that user 104 would have been interrupted by the commercial message anyway. Therefore, using this optional form, periodic permission system 100 does introduce still another interruption to displayed content.

In a similar vein, and referring specifically to FIG. 3, periodic permission system 100 may further comprise a warning functionality wherein the sensible output issues a notice of impending interruption and inhibition. In this functionality, the notice or warning is shown as a message 130 at the bottom of a screen 132. In the illustrated example, the message advises that an interruption for a query 118 will occur in a specified time. The warning may comprise a textual message as shown, or may comprise a pictorial device (not shown) such as a dial illustrating a time interval countdown. Where the sensible output comprises viewing screen 110, the notice of impending interruption may comprise an icon superimposed over viewing content.

In the above example, user 104 is a student, and the queries are in the form of simple mathematical addition problems. Periodic permission system 100 is not limited to these examples. In other implementations, user 104 may be an adult, or alternatively, a minor who is not a student. Queries may be educational, or may test a person's knowledge of a vocation, a set of rules, general knowledge, may comprise a psychological test, or may take any form or may be directed to any knowledge set. The above example of user 104 as a child student, and queries comprising simple arithmetic problems of addition are only exemplary.

Authorized administrator 108, illustrated in FIG. 1 as a single person, may comprise more than one person, e.g., two parents, a group of school teachers, a personnel committee tasked with hiring, or still others.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

I claim:

1. A periodic permission system for controlling access of a user to a device having a control circuit and a sensible output, wherein the periodic permission system is controllable by an authorized user and is coupled to the control circuit of the device, and further comprises:
an inhibition feature periodically interrupting and inhibiting routine function of the sensible output of the device until a user has entered a response as data responsive to at least one query generated by the periodic permission system and made available to the user using the sensible output, and
a restoration feature restoring the routine function of the device responsive to the user entering a response to the query.

2. The periodic permission system of claim 1, wherein the query is a question taken from an educational lesson, and the data responsive to the query comprises an answer to the question.

3. The periodic permission system of claim 2, further comprising a functionality of establishing a third party as a subordinate authorized administrator authorized to establish at least partial content of the query.

4. The periodic permission system of claim 3, wherein the third party is a teacher, and content of the query comprises test questions and academic exercises initiated by the teacher.

5. The periodic permission system of claim 4, wherein the periodic permission system is administered from a website by a website operator and uses the internet as a communications link.

6. The periodic permission system of claim 5, wherein the teacher accesses the device by logging into the website.

7. The periodic permission system of claim 5, and the query and parameters of operation comprise modules downloadable through the internet, and through data storage apparatus connectable to the device in data transfer relationship.

8. The periodic permission system of claim 5, wherein participation of at least one of the third party and of the user is password protected.

9. The periodic permission system of claim 2, further comprising a functionality wherein an incorrectly answered query is repeated as a new query.

10. The periodic permission system of claim 2, wherein the query and the response are maintained in memory of the device and are retrievable for viewing.

11. The periodic permission system of claim 1, wherein the sensible output of the device comprises at least one of an electronically operated display screen and an electronically operated speaker.

12. The periodic permission system of claim 1, wherein
the control circuit comprises a microprocessor, and
the inhibition feature and the restoration feature are embodied in a dedicated module in supervisory control relationship to the microprocessor.

13. The periodic permission system of claim 12, wherein the dedicated module is under control of an authorized administrator of the device.

14. The periodic permission system of claim 13, wherein the dedicated module includes a time setting functionality controllable by the authorized administrator, wherein time frequency of periodic interrupting and inhibiting is established by the authorized administrator.

15. The periodic permission system of claim 1, wherein the device operates a video game for the user.

16. The periodic permission system of claim 1, further comprising a functionality
of distinguishing between primary content and commercial messages, and
initiating the inhibition feature when identifying a commercial message.

17. The periodic permission system of claim 1, further comprising a warning functionality wherein the sensible output issues a notice of impending interruption and inhibition.

18. The periodic permission system of claim 17, wherein the sensible output comprises a viewing screen, and the notice of impending interruption comprises an icon superimposed over viewing content.
